(19) United States
(12) Patent Application Publication
(10) Pub. No.: US 2004/0073555 A1
(43) Pub. Date: Apr. 15, 2004

(54) Web callbook interface for amateur radio logging systems

(76) Inventor: Dennis Hevener, Auburn, GA (US)

Correspondence Address: Dennis Hevener, 1323 Center Dr, Auburn, GA, 30011, US

(21) Appl. No.: 10/388,820

(22) Filed: Mar. 14, 2003

Related U.S. Application Data
(60) Provisional application No. 60/364,463, filed on Mar. 15, 2002.

(51) Int. Cl. G06F 17/00

(52) U.S. Cl. 707/100

(57) ABSTRACT

User enters an amateur radio callsign for which he wishes to retrieve the license holder's name, address, and other information such as latitude and longitude of his station, license class, license expiration date, and birthdate. He may enter this in a designated field in the search form callsign field (31), or in another program, such as a logging program (38). A software process searches for the specified callsign on one or more World Wide Web databases. Said process converts the information that is normally displayed in a web browser to a common record format so that the data may displayed in a consistent format (29), and be added to logging databases (39) or used to print mailing labels, envelopes, or post cards (40).

Since there is no single comprehensive database containing all amateur radio operators in the world, multiple World Wide Web databases may be searched in order to find the desired callsign and gather all possible information about the specified station. The user may select which databases are searched (23) and the order in which they are searched (20).

Many web callbook databases, such as the Federal Communications database, contain information for one political entity only (25). The Web Callbook Interface System determines the country that issued the callsign (using commonly-known methods involving lookup tables of callsign prefixes), and bypasses search of single-country databases that do not correspond to the callsign.

Web databases may be marked as “comprehensive” by the user (24). These comprehensive databases are assumed to be complete for the political entity in question. If a callsign is not found in a comprehensive database for a country corresponding to the said callsign, we know that the requested callsign was entered incorrectly and no such station exists. The process stops. It does not search any additional databases.

Revenue of commercial sites displaying advertising is preserved by displaying the site contents in a window (30). This display is presented on top of all other windows on the screen. The user must select another window or click a button (36) to continue using the program.

### CROSS-REFERENCE TO RELATED APPLICATIONS

Not Applicable

### BACKGROUND

1. Field of Invention

This invention relates to collecting information from various World Wide Web-based radio amateur callbook database and inserting into an amateur radio station logbook.

2. Description of Prior Art

Since its beginnings in the early 1900s, amateur radio operators have exchanged post cards, known in the amateur radio community as QSL cards, as proof of contacting each other. At first, when long distance communications were difficult, proof of the contact was desired to prove that an unlikely contact actually happened. Global communications soon became commonplace. However, QSLs are still desired to show proof of long-distance communications on bands where local communication is the norm, proof of some achievement such as contacting all states or one hundred countries, or simply as attractive mementos from far-away and exotic places.

In order to facilitate exchange of QSL cards, printed “Callbooks” which contain an alphabetical list of call signs with the names and addresses of amateur operators became available about 1920. With the advent of CD-ROM and personal computer technology, Sears-catalog-sized books were replaced with CD-ROMs. Besides economy, CD-ROMs could be interfaced to the computer so that information can be logged automatically by a computerized logbook. My product, LOGic, was one of the first programs to support this technology.

Currently, there are a number of web sites that have amateur callbook info, including the Federal Communications Commission, other governments and national radio clubs, as well as commercial enterprises that combine several countries into one database and profit by displaying advertisements on their web sites to users of their sites.

However, there is no single comprehensive worldwide callbook database on the web or elsewhere. A means of seamlessly searching several databases with one search request is desirable.

### SUMMARY

A web callbook interface system, comprising of a process to search multiple sites to locate the desired callsign, a module to display advertisements from commercial sites, and an interface that presents a consistent format of various web sites to the logging program.

### OBJECTS AND ADVANTAGES

Accordingly, besides the objects and advantages of paper callbooks, CD-ROM databases, and callbook web systems, several objects and advantages of my present invention are:

(a) providing a common interface so that information from differing callbook web site may be read by a logging program using a consistent method.

(b) Search multiple sites to find the desired callsign, with user control over which sites are searched, and the order in which they are searched.

(c) Display of advertisements from commercial sites to preserve revenue of site owners. If site is not commercial, web site display or the whole user interface may be hidden to save screen space.

(d) Batch update of log records that do not contain callbook information—imported log data for example.

(e) Scanning multiple sites that contain the same callsign to gather additional data. For instance, suppose we desire the station's county and his email address. Not all databases contain all information. We can scan all databases that may contain the requested callsign, collecting the county from one and the email from another.

### DRAWING FIGURES

FIG. 1 shows the control file user interface.

FIG. 2 shows the web callbook search module displaying an FCC search.

FIG. 3 shows a typical ham radio logging program and how information retrieved from a callbook database is used.

### REFERENCE NUMERALS IN DRAWINGS

20 Slider to change order of control records.

21 Control file display area.

22 Description.

23 Control to disable site.

24 Control to mark site as comprehensive.

25 Display of which political entity the database serves.

26 Indicates a commercial site that has advertisements.

27 Display of URL.

28 Search form.

29 Formatted results display area.

30 Web page display area.

31 Callsign to search for.

32 Manual selection of database to search.

33 Display web page in normal browser.

34 Displays which database the results were found in.

35 Control to hide web display (only if no advertisement).

36 Sets display to preferred state after viewing ad.

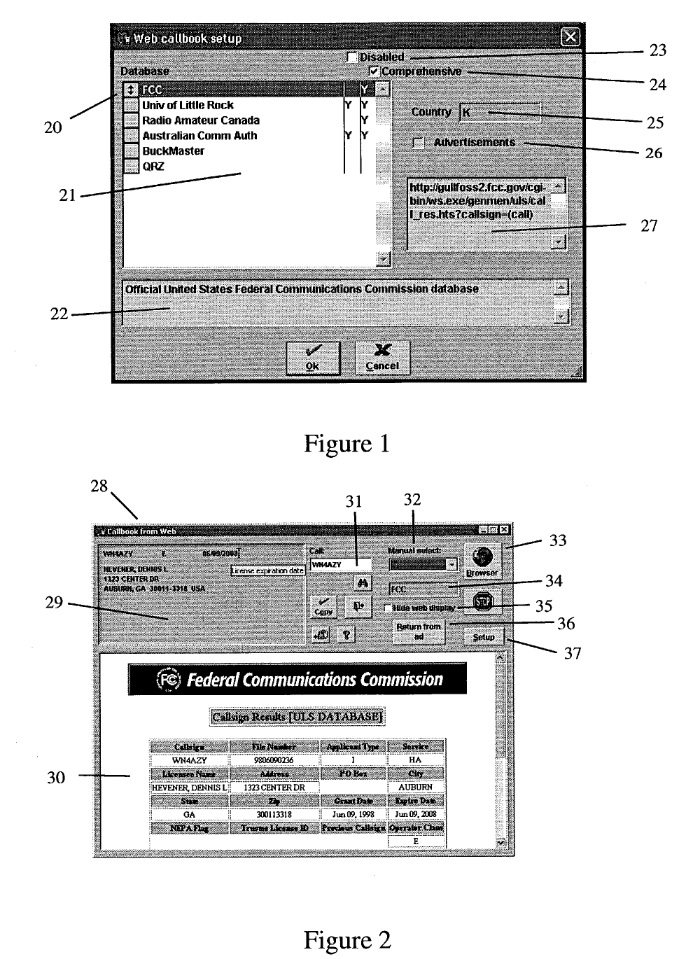

37 Opens control file setup window (FIG. 1).

38 Logging program input/output form.

39 Name, City, and State captured from web callbook interface and stored in logging program.

40 Complete name and address captured from web callbook interface, formatted for printing labels, envelopes, or post cards.

### DESCRIPTION—FIGS. 1 through 3

FIG. 1 shows the control file data (21) and user interface screen. Here, the user may select which databases to search (23), the order in which to search them (20), and whether or not the database is to be considered comprehensive for the political entity it serves (24). If a callsign is not found on a comprehensive database, the callsign is presumed not to exist and searching is terminated.

Also displayed is a description of the database (22), whether or not the site has advertisements (26), and the URL of the database (27).

FIG. 2 shows the search form. Entering a call in the input area (31) starts a search. Sites are searched until the desired information is found. When all information has been gathered, it is displayed in the display area (30).

The user may hide the web display area by clicking on the control (35) or may hide the window completely. If a site with an advertisement is scanned, the window and web display area is opened brought to the top off all other windows if any, regardless of the control setting (35). When an ad is displayed, the user may click the control (36) to return the window and web display area to the desired state (hidden, or web display area hidden).

If the user wishes to see the web site in a normal browser, he may click the browser button (33).

To open the control file user interface form, click the setu[ button (37).

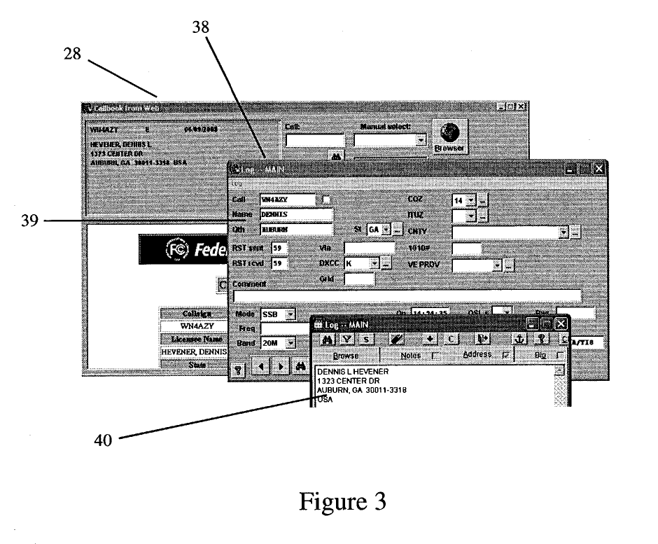

FIG. 3 shows a popular ham radio logging program. By logging a callsign, a web callbook database search is initiated programmatically by sending the callsign to search form (28). Upon completion of a search, the retrieved data may be automatically logged in the log screen (39) or used to print mailing labels, envelopes, or post cards (40).

### PROGRAMMING LOGIC

Following are detailed programming specifications for the software.

1) Create an object that, when given a callsign, navigates to the web site that displays information for said callsign.

a) Include properties for data elements that you desire to log, including name, address, license class, etc.

b) Subclass said module for each web site you wish to interface to. Include code specific to the web site to extract data elements and store to appropriate properties in said module.

2) Control file and control file user interface

a) Create a file with fields to contain the following information:

i) A description of the site.

ii) The URL of the site

iii) The name of the subclassed module used to decode the data (1b above)

iv) A disable flag, to disable search of this site.

v) An order indicator to tell the program in which order to scan the sites

vi) A flag to indicate if the site is a commercial site with advertising displays

vii) An indication of which political entity if any the site is specific to

viii) A flag to indicate if the database is comprehensive for said country. For instance, the FCC database contains all US callsigns. If we search it using a US call, and it is not found, we know the callsign is non-existant.

ix) A disable flag

x) A description to contain additional descriptive information about the site.

b) Populate the fields

c) Create a user interface form that displays the above fields, and allows the user to change order and disable and comprehensive status.

3) Create a search form to search web site and display data

a) Include a display field for each data element property.

b) Include a window to display the web page with the callbook data and any advertisements on the page. Provide controls to open the web page in a normal web browser.

c) Include controls to hide the entire window or the web display portion.

d) Include controls to manually select a specific site to search.

e) provide search logic:

i) Analyze the callsign to determine what political entity it belongs to.

ii) Scan the control file from the lowest order to the highest. Skip disabled records.

iii) If the site is for the political entity of the callsign, or if the site is not specific to a particular entity, search it. If all information has been found, proceed to next step. If unsuccessful:

(1) If this database is marked as comprehensive, discontinue scan and report that the callsign does not exist.

(2) If the database is not marked as comprehensive, continue scan.

iv) If the information has been collected, notify the logging program so it may consume the collected data. If the site is commercial, display the advertisement and move the window to the top of all other windows. If the site is not commercial, set the hidden state of the user interface or the web display to the desired state.

I claim:

1. A machine for formatting amateur radio callbook information from a world wide web database display that is intended to be viewed in a web browser, into a consistent record format, comprising:
a. A character input means which a human operator can use to store an amateur radio callsign in memory.
b. A means for transmitting the amateur radio callsign over the world wide web to a earchable callbook database.
c. A web display device for optionally displaying results from said transmission of radio amateur callsign.
d. A memory to contain the results of said transmission of amateur radio callsign.
e. A means of analyzing said memory containing results to determine if the callsign was found.
f. A means for analyzing said memory containing results to extract elements such as name, address, etc.
g. A record structure in memory to store said extracted elements.
whereby allowing said data to be used for automatic lookup from an ham radio logging program, without entering data into a web browser.
whereby allowing inserting retrieved data into a logging database or printing mailing labels, envelopes, or post cards.

2. The web display device in claim 1 incorporates a means to force display of web page results from sites that are commercial
whereby the advertising revenue for the operators of said sites is preserved.

3. The machine in claim 1 incorporates a means of searching a plurality of web callbook database sites, said means comprising:
a. A means of determining the political entity to which the callsign entered by the user corresponds, and searching only relevant databases.
b. A stored control file of world wide web callbook databases sites to be searched, comprising:
(1) Web address.
(2) Political entity if any to which the callbook database site serves.
(3) An indicator of comprehensiveness that indicates whether or not site has a complete listing of all callsigns for the political entity, if any, that it serves, signifying that the callsign does not exist, and terminating search of additional databases.
d. For each entry in said stored list of web callbook database sites, a user-modifiable bypass flag causing search of said site to be bypassed.
e. For each entry in said stored list of web callbook database sites, a user-modifiable sequence indicator to determine the order in which said plurality of databases are searched.
whereby greatly increasing the chances of locating desired data without manually initiating multiple searches.
